(19) United States
(12) Patent Application Publication
(10) Pub. No.: US 2016/0332565 A1
(43) Pub. Date: Nov. 17, 2016

(54) VEHICLE SOUND GENERATOR

(71) Applicant: HONDA MOTOR CO., LTD., Tokyo (JP)

(72) Inventors: Dohta YAMAMOTO, Wako (JP); Yuji KUBOTA, Wako (JP)

(21) Appl. No.: 15/077,485

(22) Filed: Mar. 22, 2016

(30) Foreign Application Priority Data
May 12, 2015 (JP) 2015-097578

(51) Int. Cl. B60Q 5/00

(52) U.S. Cl. CPC B60Q 5/008

(57) ABSTRACT

A vehicle sound generator includes a transmission case, a differential case rotatable with respect to the transmission case, a striking member disposed on the differential case, and a vibration plate disposed on the transmission case. The striking member is disposed so as to come in contact with the vibration plate when the differential case rotates. The rotation of the differential case allows the striking member and the vibration plate to generate a striking sound.

### CROSS REFERENCES TO RELATED APPLICATIONS

The present application claims priority under 35 U.S.C. §119 to Japanese Patent Application No. 2015-097578, filed May 12, 2015, entitled “Vehicle Sound Generator.” The contents of this application are incorporated herein by reference in their entirety.

### BACKGROUND

1. Field

The present disclosure relates to a vehicle sound generator for a vehicle that produces less running noise, such as a vehicle having an electric motor as a drive source. The vehicle sound generator generates alert sounds for alerting the presence of the vehicle approaching.

2. Description of the Related Art

HEV or EV vehicles propelled by using an electric motor as the drive source (operating in electric mode) produce considerably less noise than conventional internal combustion vehicles. Thus, pedestrians, for example, do not hear the running noise, making it difficult for them to be aware of the HEV or EV vehicles approaching in some cases. To solve the problem, some conventional HEV or EV vehicles include a speaker for producing vehicle approaching sounds (alert sounds) composed of electric sounds (see Japanese Patent No. 5333260, for example). A vehicle approaching sound controller described in Japanese Patent No. 5333260 is designed to generate effective alert sounds in accordance with conditions such as a running speed of the subject vehicle, whether or not another vehicle is traveling ahead of the subject vehicle, the distance between the subject vehicle and the vehicle traveling ahead, and the level of the road noise or noise generated by the subject vehicle, i.e., in accordance with the conditions of the subject vehicle and the conditions relating to the vehicle driving ahead.

### SUMMARY

The vehicle approaching sound controller described in Japanese Patent No. 5333260 includes a vehicle speed sensor, an on-board camera having an illuminance measurement function, a road noise detection sensor, a microphone, an alert sound level controller, and an alert sound generator. The alert sound level controller controls the volume level of the vehicle approaching sounds and the alert sound generator generates alert sounds. Such a system has a high cost and no alert sounds are generated if an electrical fault occurs.

The present application describes a reliable vehicle sound generator generating vehicle approaching sounds mechanically.

According to a first aspect of the present application, a vehicle sound generator (a vehicle sound generator 10 of an embodiment, for example, which is described later) includes a case (a transmission case 52 of the embodiment, for example), a rotational member (a diff case 51 of the embodiment, for example) rotatable with respect to the case, a first member (a striking member 20 of the embodiment, for example) disposed on the rotational member, and a second member (a vibration plate 30 of the embodiment, for example) disposed on the case. The first member is positioned so as to come in contact with the second member when the rotational member rotates, and the rotation of the rotational member allows the first member and the second member to generate a striking sound.

In the first aspect, since the rotation of the rotational member allows the first member and the second member to come in contact with each other so as to generate the striking sound, the vehicle approaching sound for alerting people outside the vehicle to the presence of the vehicle approaching is generated without an electrical energy. In addition, since the vehicle approaching sounds are generated mechanically, reliable vehicle sound generators are produced at a low cost.

According to a second aspect of the present application according to the first aspect, the first member may include an elastic member (a leaf spring 21 of the embodiment, for example) inclined with respect to a side surface of the rotational member and a striking portion (a striking portion 22 of the embodiment, for example) disposed on a front end of the elastic member so as to come in contact with the second member. The elastic member may be configured such that the striking portion comes in contact with the second member when the rotational member rotates at a speed slower than or equal to a first speed (c (rpm) of the embodiment, for example), and the striking portion does not come in contact with the second member due to a centrifugal force when the rotational member rotates faster than the first speed.

In the second aspect, the elastic member deforms elastically due to the centrifugal force and the striking portion does not come in contact with the second member when the speed of the vehicle reaches a certain speed and a running noise is generated by the tires, for example. The running noise enables people outside the vehicle to be aware of the presence of the vehicle approaching. The vehicle sound generator generates the striking sound only when the vehicle travels at speeds requiring the vehicle approaching sound to be generated for alerting people outside the vehicle to the presence of the vehicle approaching.

According to a third aspect of the present application according to the second aspect, the second member may include at least a first contact portion (a vibration arm 33 of the embodiment, for example) and a second contact portion (a vibration arm 34 of the embodiment, for example). The elastic member may be configured such that the striking portion comes in contact with the first contact portion and the second contact portion when the rotational member rotates at a speed slower than or equal to a second speed (b (rpm) of the embodiment, for example) lower than the first speed, the striking portion does not come in contact with the first contact portion due to the centrifugal force and comes in contact with the second contact portion when the rotational member rotates at a speed faster than the second speed and slower than or equal to the first speed, and the striking portion does not come in contact with the first contact portion and the second contact portion due to the centrifugal force when the rotational member rotates faster than the first speed.

In the third aspect, tones or the numbers of the striking sounds are varied according to the speed of the vehicle.

According to a fourth aspect of the present application according to any one of the first to third aspects, the first member and the second member may come in contact with each other at least twice per rotation of the rotational member to generate striking sounds, and the striking sounds are not generated at equal intervals when the rotational member rotates at a constant rotational speed.

In the fourth aspect, since the striking sounds are generated at unequal intervals, the striking sounds are more recognizable.

According to a fifth aspect of the present application according to the fourth aspect, the striking sounds do not generate a discord.

In the fifth aspect, the striking sounds give people outside the vehicle less unpleasant feeling.

According to a sixth aspect of the present application according to any one of the first to fifth aspects, the case is a transmission case (a transmission case 52 of the embodiment, for example) housing a transmission, and the rotational member is a differential case (a diff case 51 of the embodiment, for example) housing a differential.

In the sixth aspect, the striking sound is generated in conjunction with the rotation of wheels. In addition, since the differential case, which is positioned most downstream of the power transmission pathway, is the rotational member, people outside the vehicle are easy to hear the striking sound. In addition, if an unattended vehicle travels down a slope, for example, i.e., if a vehicle travels unintentionally, this configuration generates the vehicle approaching sounds, making the pedestrians be aware of an emergency situation in an early stage.

### BRIEF DESCRIPTION OF THE DRAWINGS

FIG. 1 is a cross-sectional view illustrating an embodiment of a vehicle sound generator mounted in a differential.

FIG. 2 is a perspective view illustrating a striking member, which is attached to a differential case, and a vibration plate.

FIG. 3 is a side view illustrating major components and indicating a positional relationship between the striking member and the vibration plate in a vehicle traveling at an extremely low speed.

FIG. 4 is a chart indicating a state in which six striking sounds are generated per rotation of the differential case in the vehicle traveling at the extremely low speed.

FIG. 5 is a side view illustrating the major components and indicating a positional relationship between the striking member and the vibration plate in a vehicle traveling at a low speed.

FIG. 6 a chart indicating a state in which four striking sounds are generated per rotation of the differential case in the vehicle traveling at the low speed.

FIG. 7 is a side view illustrating the major components and indicating a positional relationship between the striking member and the vibration plate in a vehicle traveling at a medium speed.

FIG. 8 is a chart indicating a state in which two striking sounds are generated per rotation of the differential case in the vehicle traveling at the medium speed.

FIG. 9 is a side view illustrating the major components and indicating a positional relationship between the striking member and the vibration plate in a vehicle traveling at a high speed.

FIG. 10 is a chart indicating a state in which no sound is generated in the vehicle traveling at the high speed.

### DESCRIPTION OF THE EMBODIMENTS

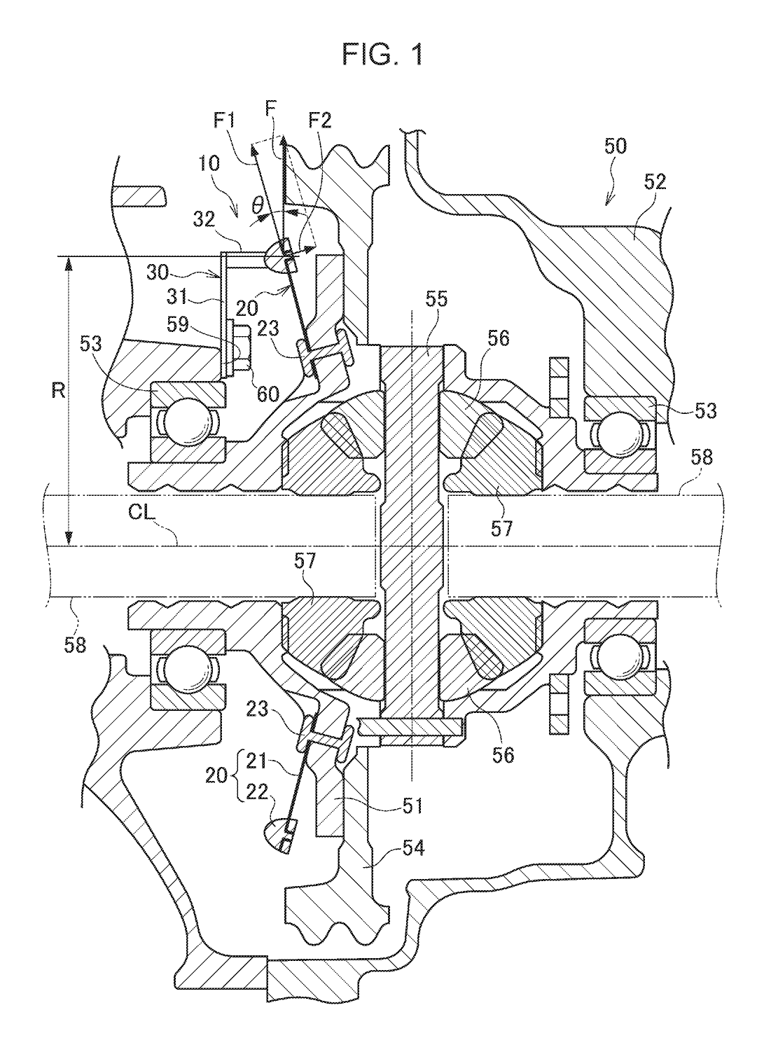

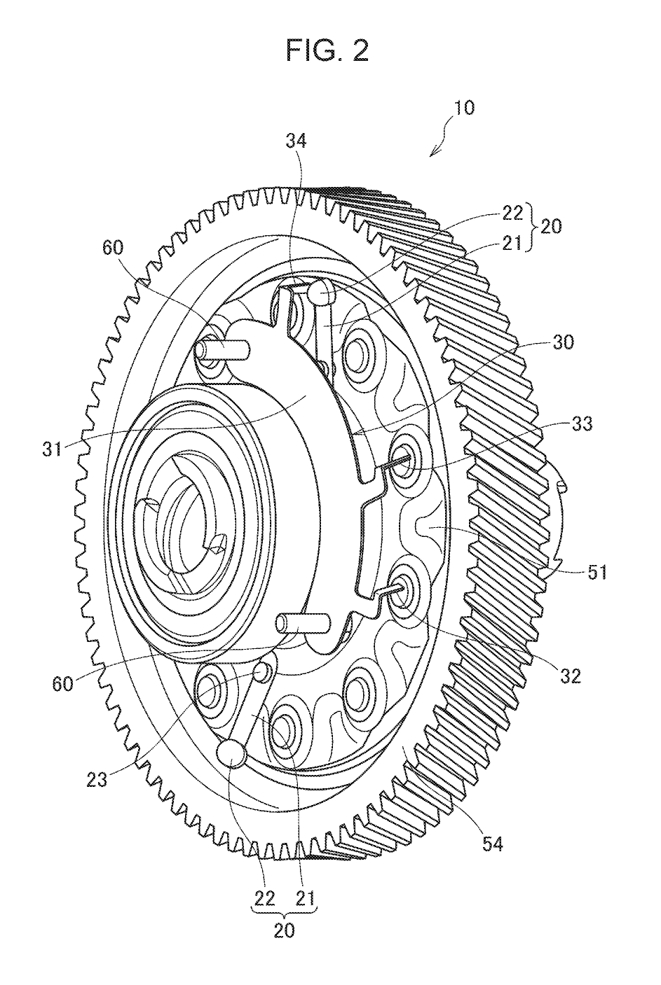

Hereinafter, an embodiment of the present disclosure is described with reference to the drawings. FIG. 1 is a cross-sectional view of a vehicle sound generator, which is mounted in a differential and according to the embodiment. FIG. 2 is a perspective view of a striking member, which is attached to a differential case, and a vibration plate, which is attached to the transmission case.

As illustrated in FIG. 1 and FIG. 2, a vehicle sound generator 10, which is mounted in a differential 50, includes two striking members 20 and a vibration plate 30.

The differential 50 is described first. The differential 50 is a device designed to transmit a torque generated by a drive source such as an engine, which is not illustrated, to the drive wheels, which are not illustrated, while compensating for the rotational differences. A differential case 51 (hereinafter, simply referred to as a diff case) of the differential 50 is rotatably supported by a transmission case 52 through a bearing 53. A ring gear 54 is integrally fixed to the diff case 51. The ring gear 54 engages with a drive gear, which is not illustrated, for rotation.

A pinion shaft 55 extending vertically through the inside of the diff case 51 is fixed to the diff case 51 in a non-rotatable manner. In the diff case 51, two pinion gears 56 are rotatably attached to the pinion shaft 55.

Two side gears 57 engage with the corresponding two pinion gears 56. The side gears 57 each have an end (inner end) facing the pinion shaft 55 with a very small distance therebetween and another end (outer end) coupled to an axle shaft 58, which is connected to left and right drive wheels. A rotation axis of the pinion gear 56 extends perpendicular to a rotation axis of the ring gear 54. A rotation axis of the side gear 57 extends perpendicular to the pinion gear 56 and parallel to the rotation axis of the ring gear 54.

The differential 50 increases or decreases the rotational speed of the two side gears 57 as necessary when the vehicle turns, for example, so as to compensate for the rotational difference between the left and right wheels, and allows the torque from the engine to be transmitted to the left and right wheels through the axle shaft 58 for propelling the vehicle.

The striking member 20 includes a leaf spring 21, which is an elastic member, and a striking portion 22 fixed to a front end of the leaf spring 21. The striking portion 22 is formed of metal, for example. The leaf spring 21 is a rectangular thin plate and the base end is fixed to a side surface of the diff case 51 with a rivet 23, for example. Specifically, the leaf spring 21 is fixed to the side surface of the diff case 51 (surface extending substantially perpendicular to a rotation axis CL of the diff case 51) such that the front end portion, i.e., the striking portion 22, is inclined toward the vibration plate 30 at a predetermined angle θ.

The leaf spring 21 is fixed such that the short side extends along the side surface of the diff case 51 and the long side extends in a radial direction. In other words, the leaf spring 21 has a high stiffness in a circumferential direction of the diff case 51 and is unlikely to deform in the circumferential direction and has a low stiffness in a direction along a rotation axis CL of the diff case 51 and is able to deform elastically in the direction along the rotation axis CL.

Two striking members 20 are fixed on the side surface of the diff case 51 so as to have a phase difference of 180° in the circumferential direction. The striking members 20 rotate along with the diff case 51. When the striking members 20 rotate together with the diff case 51, the leaf springs 21 are deformed elastically in a direction along the rotation axis CL of the diff case 51 by a centrifugal force F acting on the striking portions 22, which are solid members fixed to the front end of the corresponding leaf springs 21. The elastic deformation of the leaf spring 21 by the centrifugal force F is described in detail later.

The phase difference of the striking members 20 is not limited to 180° and may be any value. In addition, the number of the striking members 20 is not limited to two and may be any value.

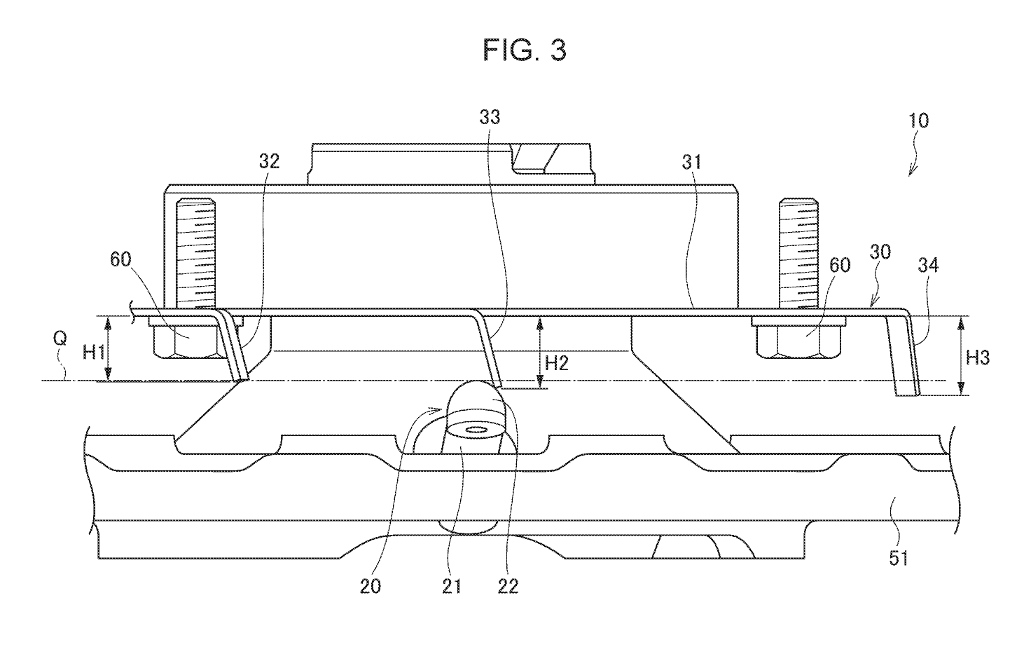

The vibration plate 30 includes a base 31 having a substantially arc shape and three vibration arms 32, 33, and 34 extending radially outward from an outer periphery of the base 31. The vibration arms 32, 33, and 34 further extend in a bent form toward the diff case 51 (striking member 20). The height H1 of the vibration arm 32 from the base 31 is the shortest, followed in order by the height H2 of the vibration arm 33, and the height H3 of the vibration arm 34 (see FIG. 3). The base 31 of the vibration plate 30 is fixed to a side surface 59 of the transmission case 52, which faces the diff case 51, by a bolt 60. In FIG. 2 to FIG. 10, the transmission case 52 is not illustrated.

The vibration plate 30 is fixed to the transmission case 52 such that the three vibration arms 32, 33, and 34 are positioned on a rotation trajectory Q of the striking members 22, which rotate together with the diff case 51. When the striking members 20 rotate with the diff case 51, the striking portions 22 sequentially come in contact with the vibration arms 32, 33, and 34 and, as a result, generate striking sounds.

The frequencies of the striking sounds (pitch of the sounds) are varied depending on natural vibration frequencies determined by the length, width, and thickness of each of the vibration arms 32, 33, and 34. Thus, the tone of the striking sound is controllable by changing the natural vibration frequency of the vibration arms 32, 33, and 34.

The striking members 20 and the vibration plate 30 are disposed in the transmission case 52 that stores a lubricant oil. Thus, the lubricant oil is attached to the striking members 20, which rotate together with the diff case 51, every time the diff case 51 rotates. If the vibration plate 30 is immersed in the lubricant oil, he striking sounds generated are small and are unlikely to be transmitted to the outside. Thus, the vibration plate 30 is preferably disposed on an upper section of the transmission case 52 so as to prevent the vibration plate 30 from being immersed in the lubricant oil. The lubricant oil attached to the striking member 20 (striking portion 22) does not have much influence on the striking sound and reduces wear caused by the contact between the striking portion 22 and the vibration plate 30.

An operation of the vehicle sound generator of the present embodiment having the above-described configuration is described with reference to FIG. 3 to FIG. 10.

A centrifugal force of F=mRω² acts on the striking portion 22 in a radially outward direction, in which m represents a mass of the striking portion 22, R represents a distance between the rotation axis CL of the diff case 51 and the center of the striking portion 22, and co represents an angular velocity of rotation of the diff case 51 (striking member 20) as indicated in FIG. 1. Since the mass m of the striking portion 22 and the distance R between the rotation axis CL of the diff case 51 and the center of the striking portion 22 are constant, the magnitude of the centrifugal force F is determined by the angular velocity of rotation co of the diff case 51 (striking member 20), i.e., the vehicle speed. A component force F1=Fcosθ acts on the leaf spring 21 in the longitudinal direction of the leaf spring 21 and a component force F2=F sin θ acts on the leaf spring 21 in the direction perpendicular to the longitudinal direction. The component force F2 deforms the leaf spring 21 elastically such that the striking portion 22 is away from the vibration plate 30.

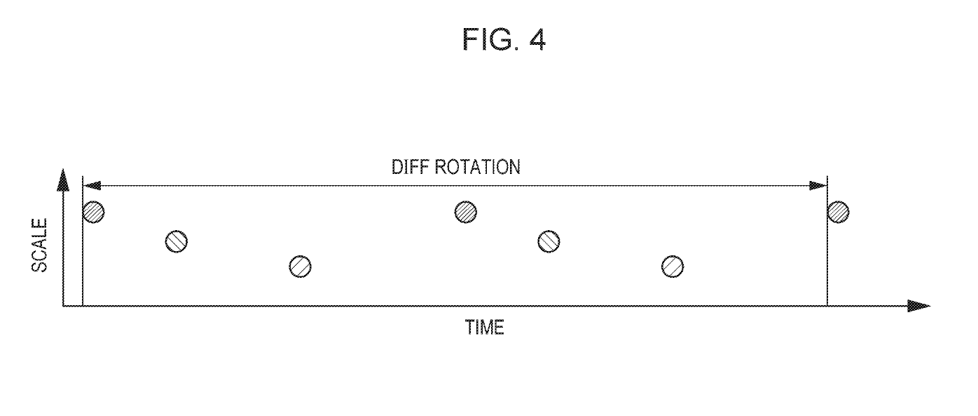

As illustrated in FIG. 3 and FIG. 4, when the vehicle travels at an extremely low speed, i.e., when the rotational speed V of the diff case 51 is 0 (rpm)<V≦a (rpm), the centrifugal force F acting on the striking portions 22 is small, and thus the leaf springs 21 deform very little elastically. Therefore, the striking portions 22 sequentially come in contact with the three vibration arms 32, 33, and 34 so as to generate the striking sounds according to the natural vibration frequencies, making people outside the vehicle be aware of the vehicle approaching.

In FIGS. 4, 6, 8, and 10, “DIFF ROTATION” indicates one rotation of the diff case 51. Circles on the top indicate striking sounds generated by the contact between the striking portions 22 and the vibration arm 32. Circles in the middle indicate striking sounds generated by the contact between the striking portions 22 and the vibration arm 33. Circles on the bottom indicate the striking sounds generated by the contact between the striking portion 22 and the vibration arm 34. Hatched solid circles indicate striking sounds that are actually generated, and hatched dashed circles indicate striking sounds that are not generated because the striking portions 22 strike at the air.

Since the vehicle sound generator 10 of this embodiment includes two striking members 20 and three vibration arms 32, 33, and 34, six striking sounds are generated per rotation of the diff case 51. Intervals of the striking sounds are determined by circumferential spaces (phases) between the three vibration arms 32, 33, and 34.

The striking sounds may be generated at regular intervals. However, the striking sounds are preferably generated at irregular intervals by the vibration arms 32, 33, and 34 positioned at irregular intervals so as to make people outside the vehicle be more aware of the vehicle approaching. Echoes of the striking sounds generated by the vibration arms 32, 33, and 34 overlap in some cases. The striking sounds of the vibration arms 32, 33, and 34 are preferably in such tones that the overlapping striking sounds do not generate a discord that gives unpleasant feeling to people who hear the echoes.

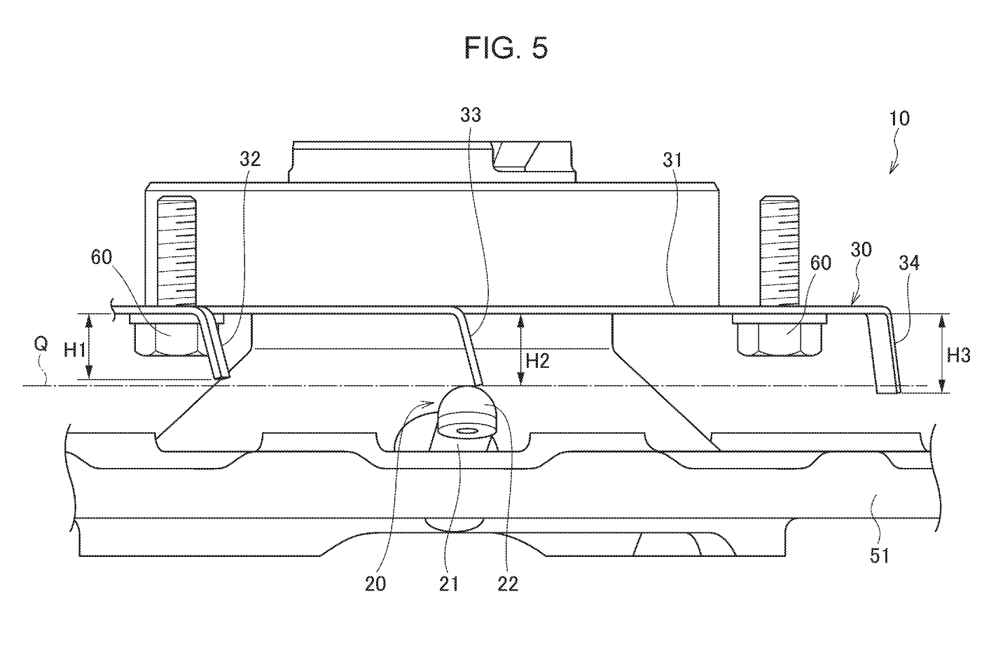

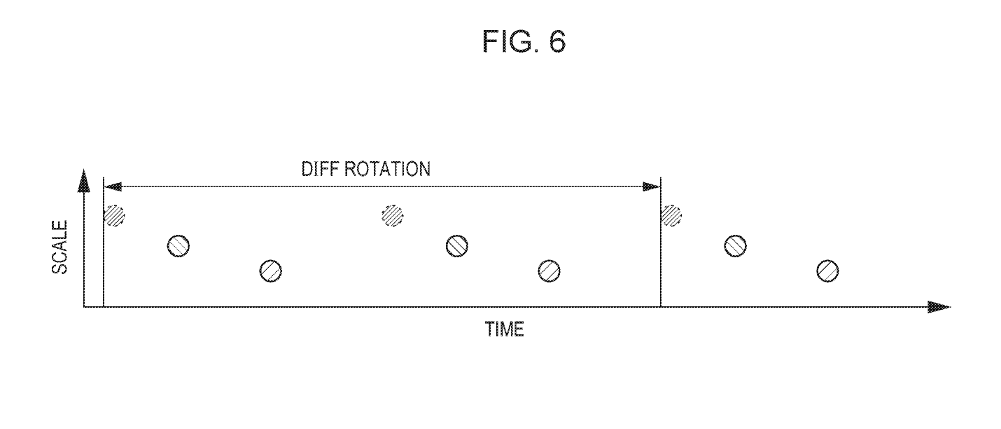

As illustrated in FIG. 5 and FIG. 6, when the vehicle travels at a low speed, i.e., the rotational speed V of the diff case 51 satisfies a (rpm)<V≦b (rpm), the component force F2 of the centrifugal force F acting on the striking portions 22 deform the leaf springs 21 elastically. As a result, the striking portions 22 do not come in contact with the shortest vibration arm 32 and come in contact with the vibration arms 33 and 34. Four striking sounds are generated per rotation of the diff case 51 by the contact between the striking portions 22 and the vibration arms 33 and 34.

The generation cycle of the striking sounds (one rotation of the diff case 51) at the low speed is shorter than that at the extremely low speed, and the number of striking sounds per cycle is different from that at the extremely low speed. Thus, it is recognizable that the vehicle is traveling at the low speed.

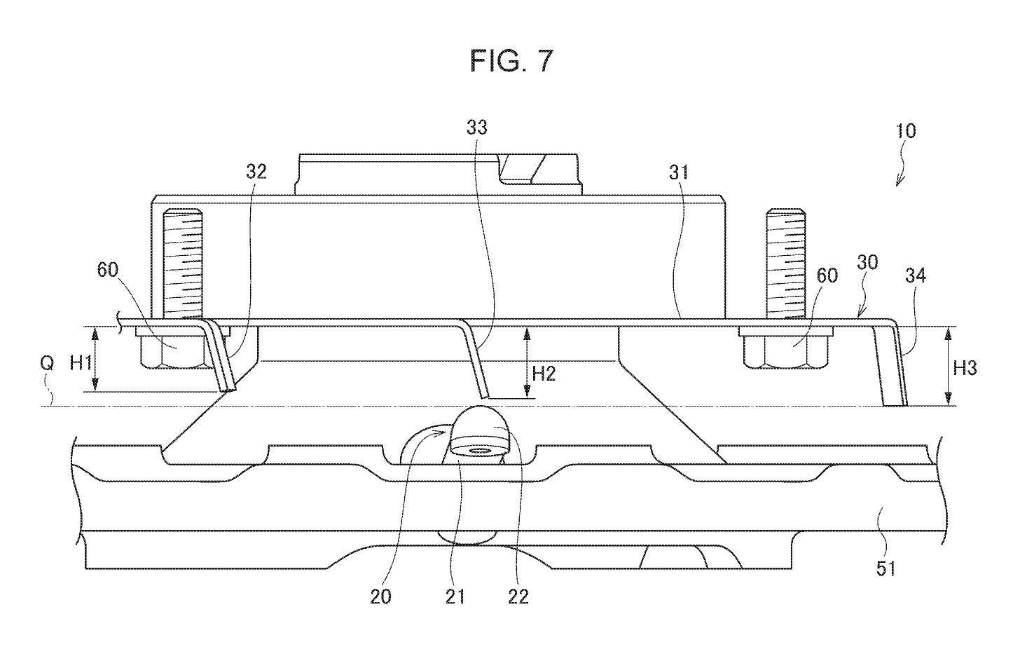

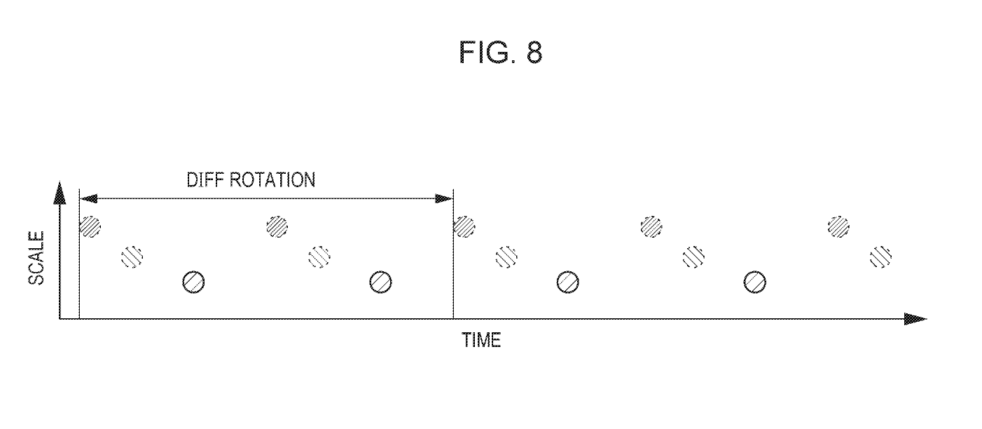

As illustrated in FIG. 7 and FIG. 8, when the vehicle travels at a medium speed, i.e., the rotational speed V of the diff case 51 satisfies b (rpm)<V≦c (rpm), the centrifugal force F acting on the striking portions 22 is large, and thus the component force F2 further deforms the leaf springs 21 elastically. As a result, the striking portions 22 do not come in contact with the shortest vibration arm 32 and the second shortest vibration arm 33 and come in contact with only the vibration arm 34. Two striking sounds are generated per rotation of the diff case 51 by the contact between the striking portions 22 and the vibration arm 34. The generation cycle of the striking sounds at the medium speed is further shorter and the number of the striking sounds in one cycle is different from those at the extremely low speed and the low speed. Thus, it is recognizable that the vehicle is traveling at a higher speed.

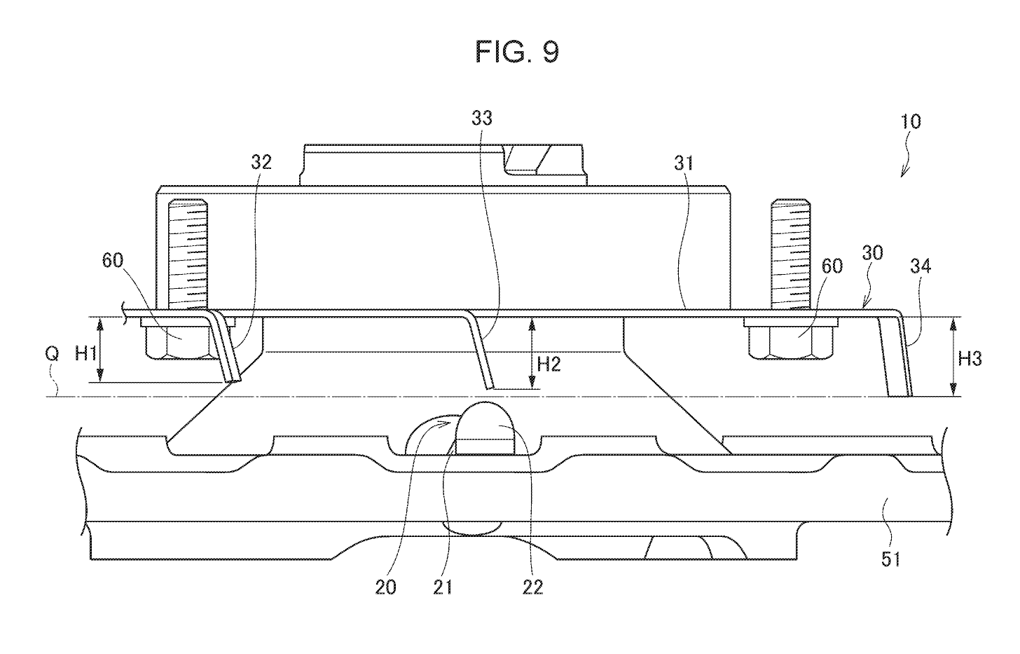

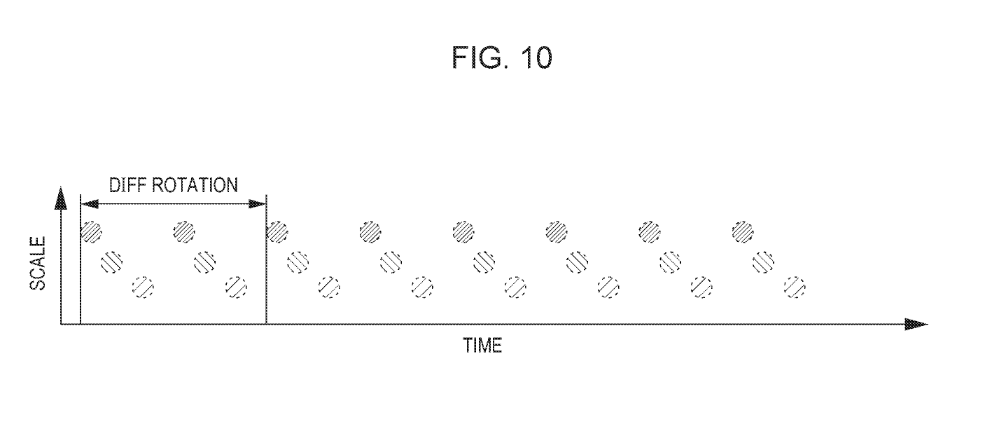

As illustrated in FIG. 9 and FIG. 10, when the vehicle travels at a high speed, i.e., the rotational speed V of the diff case 51 satisfies V>c (rpm), the centrifugal force F acting on the striking portions 22 is larger, and thus the component force F2 further deforms the leaf springs 21 elastically. As a result, the striking portions 22 do not come in contact with any one of the vibration arms 32, 33, and 34. Thus, no striking sounds are generated. In this case, the vehicle travels at a certain speed, and thus the presence of the vehicle approaching is recognizable by the running noise caused by the tires, for example.

As described above, in the vehicle sound generator 10 of this embodiment, the striking members 20 are positioned so as to come in contact with the vibration plate 30 when the diff case 51 rotates. The rotation of the diff case 51 allows the striking members 20 and the vibration plate 30 to generate the striking sounds. With this configuration, vehicle approaching sounds, which make people outside the vehicle be aware of the presence of the vehicle approaching, are generated without requiring electrical energy. Since the vehicle approaching sounds are generated mechanically, the reliable vehicle sound generator 10 is produced at a low cost.

The striking member 20 includes the leaf spring 21, which is inclined with respect to the side surface of the diff case 51, and the striking portion 22, which is disposed on the front end of the leaf spring 21 so as to come in contact with the vibration plate 30. The leaf spring 21 is configured such that the striking portion 22 comes in contact with the vibration plate 30 when the vehicle does not travel at the high speed, i.e., when the rotational speed V of the diff case 51 satisfies V≦c (rpm), and the striking portion 22 does not come in contact with the vibration plate 30 due to the centrifugal force when the vehicle travels at the high speed, i.e., when the rotational speed V of the diff case 51 satisfies V>c (rpm). With this configuration, the leaf spring 21 deforms elastically due to the centrifugal force and the striking portion 22 does not come in contact with the vibration plate 30 when the speed of the vehicle reaches a certain speed and a running noise is generated by the tires, for example. The running noise enables people outside the vehicle to be aware of the presence of the vehicle approaching. The striking sound is generated only when the vehicle travels at speeds requiring the vehicle approaching sound to be generated for alerting the people outside the vehicle to the presence of the vehicle approaching.

The vibration plate 30 includes at least the vibration arms 33 and 34. The leaf spring 21 is configured such that the striking portion 22 comes in contact with the vibration arms 33 and 34 when the vehicle travels at the low speed, i.e., the rotational speed V of the diff case 51 satisfies V≦b (rpm), the striking portion 22 does not come in contact with the vibration arm 33 due to the centrifugal force and comes in contact with the vibration arm 34 when the vehicle travels at the medium speed, i.e., the rotational speed V of the diff case 51 satisfies b (rpm)<V≦c (rpm), and the striking portion 22 does not come in contact with the vibration arms 33 and 34 due to the centrifugal force when the vehicle travels at the high speed, i.e., the rotational speed V of the diff case 51 satisfies V>c (rpm). With this configuration, the tones and the numbers of the striking sounds vary according to the speed of the vehicle.

In addition, the striking members 20 and the vibration plate 30 come in contact with each other at least twice per rotation of the diff case 51 to generate the striking sounds, and the striking sounds are not generated at equal intervals when the speed of the vehicle is constant. Since the striking sounds are generated at unequal intervals, the striking sounds are more recognizable.

The striking sounds do not generate a discord. Thus, the striking sounds are unlikely to give people outside the vehicle an unpleasant feeling.

Since the vibration plate 30 is attached to the transmission case 52 and the striking member 20 is attached to the diff case 51, the striking sounds are generated in conjunction with the rotation of the wheels. In addition, since the striking member 20 is disposed on the diff case 51, which is the component positioned most downstream of the power transmission pathway, people outside the vehicle easily hear the striking sounds. In addition, if an unattended vehicle travels down a slope, for example, i.e., if a vehicle travels unintentionally, this configuration generates the vehicle approaching sounds, making the pedestrians be aware of an emergency situation at an early stage.

The present disclosure is not limited to the above-described embodiment and may be suitably modified or improved. In the above-described embodiment, the vehicle sound generator is mounted in the differential, but is not limited to being mounted in the differential and may be mounted in any component related to vehicle movement.

What is claimed is:

1. A vehicle sound generator comprising:
a case;
a rotational member rotatable with respect to the case;
a first member disposed on the rotational member; and
a second member disposed on the case, wherein
the first member is positioned so as to come in contact with the second member when the rotational member rotates, and
the rotation of the rotational member allows the first member and the second member to generate a striking sound.

2. The vehicle sound generator according to claim 1, wherein the first member includes an elastic member inclined with respect to a side surface of the rotational member and a striking portion disposed on a front end of the elastic member so as to come in contact with the second member, and
the elastic member is configured such that:
the striking portion comes in contact with the second member when the rotational member rotates at a speed slower than or equal to a first speed; and
the striking portion does not come in contact with the second member due to a centrifugal force when the rotational member rotates faster than the first speed.

3. The vehicle sound generator according to claim 2, wherein the second member includes at least a first contact portion and a second contact portion, and
the elastic member is configured such that:
the striking portion comes in contact with the first contact portion and the second contact portion when the rotational member rotates at a speed slower than or equal to a second speed lower than the first speed;
the striking portion does not come in contact with the first contact portion due to the centrifugal force and comes in contact with the second contact portion when the rotational member rotates at a speed faster than the second speed and slower than or equal to the first speed; and
the striking portion does not come in contact with the first contact portion and the second contact portion due to the centrifugal force when the rotational member rotates faster than the first speed.

4. The vehicle sound generator according to claim 1, wherein the first member and the second member come in contact with each other at least twice per rotation of the rotational member and, as a result, generate striking sounds, and
the striking sounds are not generated at equal intervals when the rotational member rotates at a constant rotational speed.

5. The vehicle sound generator according to claim 4, wherein the striking sounds do not generate a discord.

6. The vehicle sound generator according to claim 1, wherein the case is a transmission case housing a transmission, and
the rotational member is a differential case housing a differential.
